(19) United States
(12) Patent Application Publication
(10) Pub. No.: US 2006/0232412 A1
(43) Pub. Date: Oct. 19, 2006

(54) Intelligent reader system and method for identifying and tracking goods and materials transported in pallets, including but not limited to scaffolding materials

(75) Inventors: Jorge Oscar Tabacman, Sapphire Beach (AU); Patrick F. King, Simpsonville, SC (US)

Correspondence Address: WITHROW & TERRANOVA, P.L.L.C., P.O. BOX 1287, CARY, NC, 27512, US

(73) Assignee: JORGE TABACMAN & ASSOCIATES P/L, Sapphire Beach (AU)

(21) Appl. No.: 11/403,498

(22) Filed: Apr. 13, 2006

Related U.S. Application Data
(60) Provisional application No. 60/672,143, filed on Apr. 15, 2005.

(51) Int. Cl. G08B 13/14

(52) U.S. Cl. 340/572.1; 340/572.7; 340/572.8

(57) ABSTRACT

An intelligent tracking system designed to accurately detect and track goods and/or materials present within a pallet. An identification reader is coupled to the pallet and used to detect identification devices, such as RFIDs, that are attached to the goods or materials contained therein. The pallet is constructed in a manner to allow and limit the identification reader to detect the identification devices that are contained only within the attached pallet. Thus, identification devices are automatically detected by the identification reader and information relating to the identification devices is stored in a database in order to track the contents of a specified pallet. In this manner, goods and/or materials can be continuously and accurately tracked for shipping or storing purposes in order to provide real-time tracking capabilities.

### RELATED APPLICATION

This application claims priority to U.S. Provisional Patent Application No. 60/672,143 entitled “INTELLIGENT READER SYSTEM AND METHOD FOR IDENTIFYING AND TRACKING GOODS AND MATERIALS TRANSPORTED IN PALLETS, INCLUDING BUT NOT LIMITED TO SCAFFOLDING MATERIALS,” filed on Apr. 15, 2005, and incorporated herein by reference in its entirety.

### FIELD OF THE INVENTION

The present invention relates to a communication device and communication system and method, which includes an intelligent reader to automatically identify and track goods or articles stored, removed, and transported in a pallet or like container. The goods or articles are equipped with wireless communication based identification devices that are interrogated for identification and tracking purposes.

### BACKGROUND OF THE INVENTION

It is well known in supply chain management systems to attach identification devices to goods for automatic identification and tracking of such goods. In this manner, human intervention to physically track and/or record goods during the manufacturing and transportation process within the supply chain system is not required. Two common wireless identification devices that are used to identify goods are optically read codes, such as bar codes, and radio frequency communication devices, known as radio frequency identification devices (RFID). The identification device, namely the bar code or the RFID, is attached to the goods. The RFIDs are typically passive or semi-passive, or active tag devices. The distinction is that passive tags rely on power from a remote source to function and works by backscatter. Semi-passive tags also work by backscatter similar to passive devices, except that they use a battery to make the process more efficient. Active tags have a battery and transmit directly to a receiver by a beacon mode or by being activated by a secondary function. Examples of secondary functions could be low frequency (LF), infrared, or motion sensors incorporated into the active tag.

As goods containing such identification devices are transported and stored in the supply chain system, readers are placed through the supply chain routes (often referred to as portals) that are adapted to detect the identification devices on the goods resulting in retrieval of a unique code from the identification device. If the identification code is in the form of an optically-read bar code for example, the reader would be an optical detection device also called a “reader.” If the identification code is in the form of a number code stored in the memory of a RFID tag, the reader would be a RF interrogation reader that is capable of wireless communication with the RFID tag in order to receive the code stored on the RFID tag.

After the reader detects or receives the code from the goods, the reader stores the code and typically communicates the code to a central computer or processing system that then stores the code in a database. The reader may also store other information in association with detection of a code, including as the time and date the code was detected, and an identification code of the reader where the identification occurred. In this manner, the central computer system not only determines that a good was successfully detected, but also when the good was detected and where the good was located when it was successfully detected. If multiple readers are placed at various locations in the supply chain path, the central computer can track goods having identification devices as they move in the range of one reader to another. Depending on the complexity and rules programmed into the central computer, the central computer may also detect error conditions when goods are not identified in the correct location and/or at the correct time.

As one can imagine, there are quite a number of applications and innovations that can be achieved using a supply chain tracking system. Inventory levels for goods that are used in manufacturing can be automatically tracked, and orders for new inventory can be placed automatically as inventory is depleted. The effective throughput of goods as they move through the supply chain process can be calculated since the goods can be tracked at various stages and locations in the supply chain.

In the aforementioned system, the readers are located in fixed locations in the supply chain. The goods move through the supply chain from one location to the next, but the goods are only identified when the goods encounter the next reader. This architecture is used, because it is impractical from both a cost and space perspective to provide readers at fixed locations at every stage of the supply chain system where the identification device is constantly identified in real-time and where there is no “blind spot” (i.e. the identification device is not in the range of at least one reader). Thus, with the aforementioned systems, there is a risk that goods or merchandise can be lost or stolen in transit between one reader to the next. While the central computer may eventually detect that a good has been lost in the supply chain by the good not being identified at the next expected reader location, there may be a significant amount of time before this detection occurs. Further, the exact location where the good departed from the supply chain trail cannot be determined; only the last reader to have successfully identified the good can be determined.

Further, there are other systems that use identification devices on goods for tracking purposes, but the goods are not articles of manufacture that are used to manufacture products and are not part of a supply chain process. The goods to be tracked are goods or tools that are reusable and may be used in the manufacturing process or other tasks. Some examples of such goods are hand tools that may be used when building articles of manufacture, or scaffolding materials that may be rented or leased and reused for construction projects. In the example of scaffolding materials, the materials are typically rented or checked out for temporary use and are returned. The materials are placed in pallets for transport by large trucks, and are returned in the same pallets to their original location for restocking when their use is completed. The materials are manually inventoried before being placed on the pallet, and then manually inventoried when removed from the pallet for use at the construction site. This process is repeated when the materials are returned. Obviously, this process is inefficient as it relies on manual counting of hundreds if not thousands of parts. It is also difficult to ensure that the correct number and type of goods have been delivered to a site and/or returned due to the manual inventory process. This introduces potential for conflict between the supplier and the customer, and also introduces the possibility that critical parts or tools are not properly shipped or transported to a site thereby resulting in costly delays.

RFID asset management and tracking systems appear to lend themselves nicely as a method to automate the tracking of goods transported in pallets, such as scaffolding materials for example. It has been proposed that the goods be tracked using handheld identification device readers to ensure that these reusable goods can be quickly inventoried during check-out, delivery, and return. However, use of handheld readers is still a manual process that is time consuming. Further, it may not be practical to use handheld readers in all instances, because the reusable goods may be stacked on a truck or other transportation device that is not easily accessible within the range necessary for the reader to successfully communicate with the identification devices. Thus, it becomes virtually impossible for a human to access all of the goods to identify them using a handheld reader. Further, adding a human element to tracking introduces more possibility for human error in not placing the reader in all possible locations where goods having identification devices are located. Further, the goods are only read one at a time at specific time intervals thereby still providing the ability of the goods to be misplaced or stolen and a large amount of time passing before detecting such. Therefore, tracking certain types of goods using handheld readers is impractical and/or unproductive for at least the reasons discussed above. Additionally, any time a handheld device is deployed in moving, loading, or unloading goods, a second person is required to perform the moving, loading, or unloading while a the other person uses the handheld device to track the goods.

Therefore, there exists a need to provide a better system and method for real-time tracking of asset based goods or materials, and that may be transported in pallets or other containers, which does not rely on human interaction or human controlled readers to identify the goods and employ readers that are not susceptible to location and/or interference issues, especially for goods that are transported on large trucks or areas where readers may not easily be used or be successful in reads. In addition, manual reads increase the number of steps in the business processes thus lengthening the time and increasing the cost of the supply chain business processes.

### BRIEF SUMMARY OF THE INVENTION

In general, the present invention is an identification reader that is attached or included as a part of a pallet or container (hence an “Intelligence Pallet Reader”). The basic function of the pallet is to store and/or transport goods. The goods to be stored and/or transported may contain identification devices, such as RFIDs for example, that contain unique identification codes. The pallet reader, by being placed on or as a part of the pallet, is able to automatically detect the identification codes from the identification devices that are physically contained on the goods that are placed inside or removed from the pallet. In this manner, the goods are tracked continuously in real-time while being transported in the pallet and as soon as the goods are removed from the pallet thereby allowing real-time tracking of the goods and storing of data associated with tracking in a database. In essence, the reader can be always located with the goods during their transport, which allows real-time tracking, and thus the pallet is “self-aware” with intelligence of the goods contained inside the pallet via their identification codes. The pallet, via the pallet reader, can communicate in real-time with relevant computer systems across the supply chain with information on goods or articles tagged with identification devices. This is contrary to a transportation system where the readers are fixed in relation to the pallets or containers, whereby the readers can only identify the goods at fixed (portal), discrete locations in the transportation path of the pallets or containers.

Although the present invention may be used for any type of pallet or goods that are transported by pallets, the present invention is particularly beneficial for the identification and tracking of scaffolding materials that are used in construction and are transported using pallets. Providing the reader on the pallet allows the goods to be tracked when placed inside the pallet for transport, thereby providing an accurate inventory when the goods are removed from their normal storage facility for use. In many instances, companies rent scaffolding equipment by the piece, and it is critical that a proper inventory be made for billing purposes. Further, since the pallet reader is located on the pallet, the reader can be used to automatically, without human intervention, determine the inventory of materials delivered after the pallets reach their destination. After the materials are used, the pallet reader can detect if all the materials that were unloaded have been loaded back onto the pallets so that it can be detected if materials checked out have been lost or misplaced. Lastly, after the materials are returned on the pallets, the reader allows the supplier to easily and automatically, without human intervention, determine if all of the materials checked out have been returned.

By providing a pallet reader, errors caused by manual tracking and/or counting are eliminated. Discrepancies between suppliers and customers regarding the checkout and return of materials are reduced or eliminated. The pallet reader allows the supplier and customer to determine automatically exactly what materials and in what count have been delivered and returned.

In its most basic embodiment during loading and unloading (requiring counting of stock), the Intelligent Pallet Reader takes advantage of the only step in the business process where stock is automatically passed through the reader (onto the pallet) one at a time without having to add any additional steps to the business process. The most likely situation being that any requirement for physical or manual counting of stock is actually eliminated by the Intelligent Pallet Reader.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 is an illustration of an example of scaffolding parts that may include identification devices to be tracked using RFID or other identification devices;

FIG. 2A is an illustration of an example of a typical open style pallet used to store and transport goods;

FIG. 2B is an illustration of the pallet illustrated in FIG. 2A, but includes mesh siding to form a caged type pallet;

FIG. 3 an illustration of a pallet having one or more pallet readers in accordance with the present invention to automatically interrogate goods containing identification devices placed onto or removed from the pallet;

FIG. 4 is an illustration of an example antenna field communication pattern for pallet readers attached to a pallet to provide communication coverage of the entire pallet area;

FIG. 5 is a block diagram of the pallet reader and its communication with a wireless based identification device, such as a RFID;

FIG. 6 is an illustration of a user interface and control panel for an operator to interface with the pallet reader in accordance with one embodiment of the present invention;

FIG. 7A is an illustration of one housing embodiment of the pallet reader so that the pallet reader can be attached flush against a square shaped corner post of the pallet;

FIG. 7B is an illustration of the pallet reader illustrated in FIG. 7A attached to a square shaped corner post of a pallet;

FIG. 8A is an illustration of a second housing embodiment of the pallet reader so that the pallet reader can be attached flush against a cylindrical shaped corner post of the pallet;

FIG. 8B is an illustration of the pallet reader illustrated in FIG. 8A attached to a cylindrical shaped corner post of a pallet;

FIG. 9 is an illustration of a pallet reader comprised of a portable personal digital assistant (PDA) style detachable interface that is adapted to connect to a docking cradle that is attached to the pallet;

FIG. 10 is an illustration of a pallet having a plurality of pallet readers each coupled to a separate common power source that is provided as part of the pallet;

FIG. 11 is an illustration of a pallet having built-in slot antennas in the corners posts of a pallet that are communicatively coupled to the pallet reader when the pallet reader is attached to the pallet;

FIG. 12 is an illustration of a communication architecture for a pallet reader based tracking system for retrieving, storing, and tracking goods contained in and removed from pallet readers;

FIGS. 13A and 13B are flowchart illustrations of one inventory tracking embodiment of the present invention executed by the pallet reader, docking station, or central computer for tracking goods placed inside and removed from the pallet; and

FIG. 14 is a flowchart illustration of a good removal process executed by the pallet reader, docking station, or central computer for determining if a good has been removed from the pallet.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

In general, the present invention is an identification reader that is attached or included as a part of a pallet or container. The pallet is used to store and/or transport goods. The goods to be stored and/or transported may contain identification devices, such as RFIDs for example, that contain unique identification codes. The pallet reader, by being placed on or as a part of the pallet, is able to automatically detect the identification codes from the identification devices that are physically contained on the goods that are placed inside or removed from the pallet. In this manner, the goods are tracked continuously in real-time while being transported in the pallet and as soon as the goods are removed from the pallet thereby allowing real-time tracking of the goods and storing of data associated with tracking in a database. In essence, the reader is always located with the goods during their transport, which allows real-time tracking, and thus the pallet is “self-aware” with intelligence of the goods contained inside the pallet via their identification codes. The pallet, via the pallet reader, can communicate in real-time with relevant computer systems across the supply chain with information on goods or articles tagged with identification devices. This is contrary to a system where the readers are fixed in relation to the pallets or containers, whereby the readers can only identify the goods at fixed, discrete locations in the transportation path of the pallets or containers.

Although the present invention may be used for any type of pallet or goods that are transported by pallets, the present invention is particularly beneficial for the identification and tracking of scaffolding materials that are used in construction and are transported using pallets. Providing the reader on the pallet allows the goods to be tracked when placed inside the pallet for transport, thereby providing an accurate inventory when the goods are removed from their normal storage facility for use. In many instances, companies rent scaffolding equipment by the piece, and it is critical that a proper inventory be made for billing purposes. Further, since the pallet reader is located on the pallet, the reader can be used to automatically, without human intervention, determine the inventory of materials delivered after the pallets reach their destination. After the materials are used, the pallet reader can detect if all the materials that were unloaded have been loaded back onto the pallets so that it can be detected if materials checked out have been lost or misplaced. Lastly, after the materials are returned on the pallets, the reader allows the supplier to easily and automatically, without human intervention, determine if all of the materials checked out have been returned.

By providing a pallet reader, errors caused by manual tracking and/or counting are eliminated. Discrepancies between suppliers and customers regarding the checkout and return of materials are reduced or eliminated. The pallet reader allows the supplier and customer to determine automatically exactly what materials and in what count have been delivered and returned.

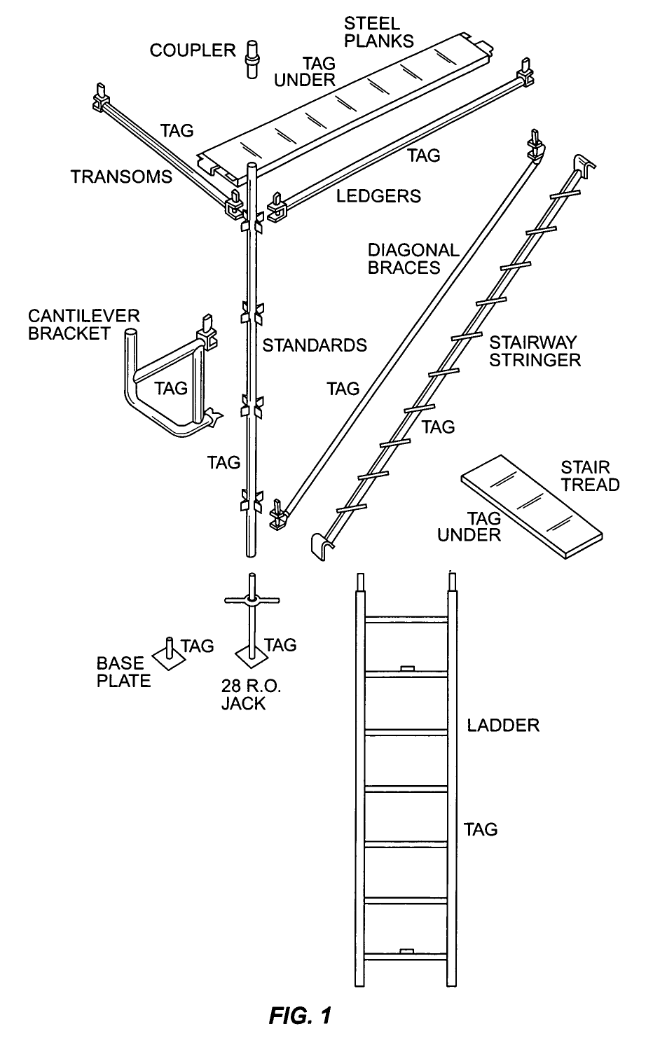

As example only, FIG. 1 illustrates examples of materials that may be desired to be automatically identified and tracked as an example. FIG. 1 illustrates scaffolding materials that are commonly used and reused at construction sites where tracking may be desired to prevent theft and misplacement as described in the “Background of the Invention” above. An object of the invention is to provide a better and more efficient method of tracking these types of goods or other goods that are stored and/or transported. Scaffolding parts are typically tubular or flat. The parts shown in FIG. 1 include the term “TAG” for each part that may be desired to be tagged with an identification device as an example.

Pallet Example

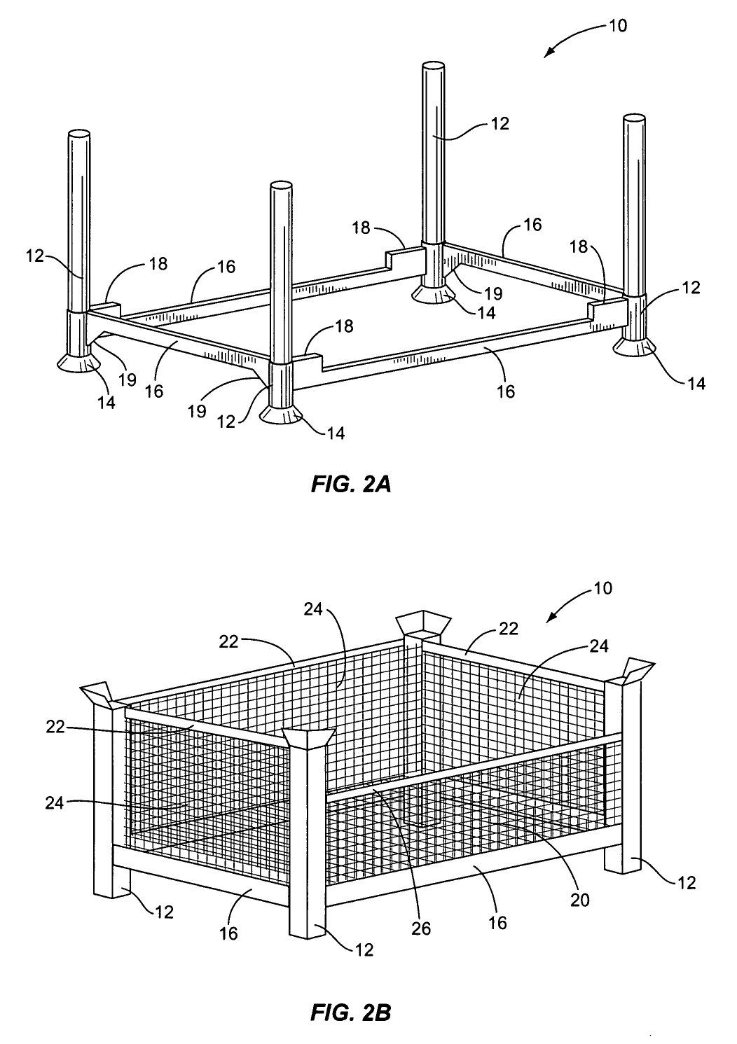

FIGS. 2A and 2B provide illustrations of examples of pallets in the prior art that may be used with the present invention. Before discussing the particular aspects of the pallet reader, examples of pallets are briefly discussed first. The pallet illustrated in FIG. 2A does not include side meshing, whereas the pallet illustrated in FIG. 2B provides enclosed sides typically used for transporting of smaller goods and materials that would fall off or outside of the pallet if not contained. In one example of the present invention the pallet 10 is constructed of welded steel piping or similar metal, wherein the pallet 10 is not easily damaged or deformed by the goods or materials it is designed to hold. Additionally, the type of metal used in the construction of the pallet 10 will be suitable to properly reflect and contain transmitted signals from the chosen pallet reader, which will also be discussed below.

As illustrated in FIG. 2A, a pallet 10 in accordance with one embodiment of the present invention is illustrated. The pallet 10 is comprised of four corner posts 12 that support the pallet 10. The corner posts 12 may be any shape including cylindrical, or a polygon comprised of two or more sides. The corner posts 12 may be constructed out of metal, plastic, or any other type of material desired. The bottoms of the corner posts 12 may contain footings 14 so that the pallet 10 is more balanced when resting on the ground as opposed to the corner posts 12 resting directly on the ground. The corner posts 12 are connected together by side posts 16. The side posts 16 may contain additional flaps 18 at their ends that connect to the corner posts 12 to provide greater stability at the connection point of the corner posts 12 to the side posts 16. Diagonally placed rods 19 may also be used to connect the portion of the corner posts 12 below the connection point between the side posts 16 and the corner posts 12 to provide further stability.

FIG. 2B also illustrates a pallet 10 like that illustrated in FIG. 2A, except that the pallet 10 illustrated in FIG. 2B contains mesh siding 24. A base 20 is typically placed inside the areas formed by the side posts 16 so that materials or goods can be stacked on the pallet 10 for storage and/or transport. Support bars 22 are provided along the top edge of the side meshing 24, which are connected to the mesh housing 24 and to the corner posts 12 to provide an enclosed area within the four corner posts 12 of the pallet 10. The side meshings 24 provide the ability to contain goods or materials that are smaller in nature or cannot be stacked and/or retained on the pallet 10 as illustrated in FIG. 2A without falling off the base 20. Another example of a pallet 10 similar to that disclosed in FIGS. 2A and 2B that may be used with the present invention is the “Rigid Wire Mesh Container” disclosed at http://www.pallet-container-quotes.com/wire-pallet-containers.htm, which is incorporated herein by reference in its entirety.

Pallet Reader Example

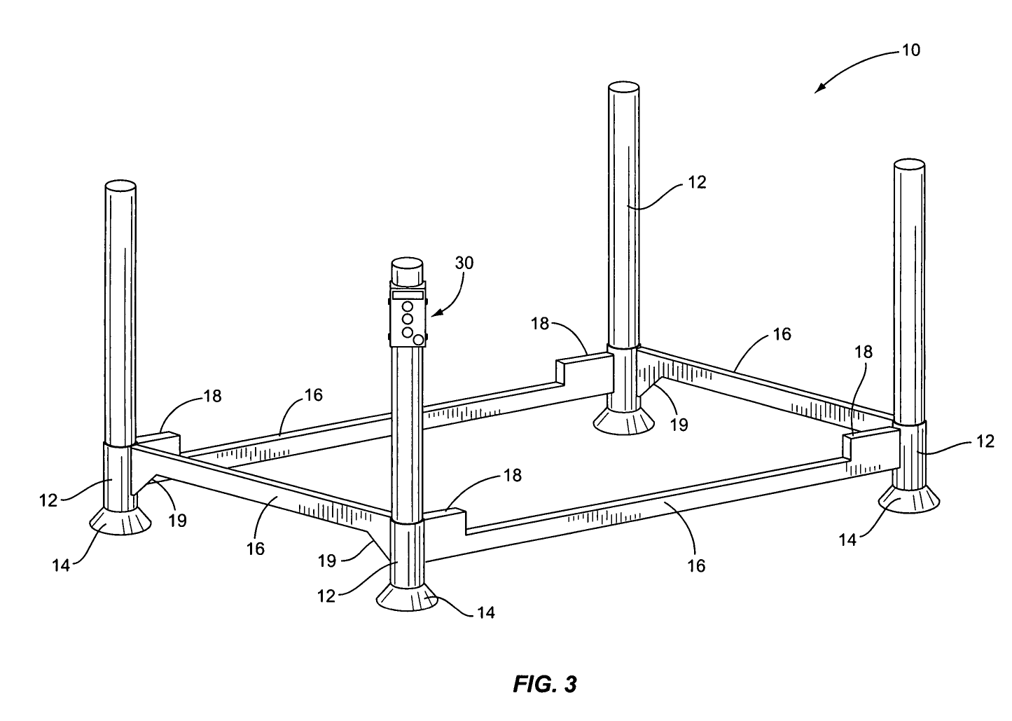

One desired goal of the invention is to provide a pallet reader that provides a communication range sufficient to cover all areas of the pallet 10 such that any goods having identification devices attached thereto can be “seen” by the pallet reader. Depending on the design of the reader and its range, one or more readers may be provided. FIG. 3 illustrates the pallet 10 with a pallet reader 30 attached as shown. In this embodiment, only one pallet reader 30 is provided, although it is understood that the present invention is not limited to any particular number of pallet readers 30 and that up to four pallet readers 30 may be provided, one on each corner post 12 of the pallet 10 illustrated. The pallet reader 30 illustrated is attached to a corner post 12 on the pallet 10.

Depending on the antenna chosen for the pallet reader 30, the operating frequencies of the reader 30, the power, and the communication range of the pallet reader can vary. It may be desirable for example to limit the range of the identification device detected by the pallet reader 30 to a certain distance based on the size of the pallet 10, so that the fields are limited and overlap between fields from different readers 30 is minimized. For example, it may be desirable to limit the read distance to between 0.5 and 1.0 meters depending on design.

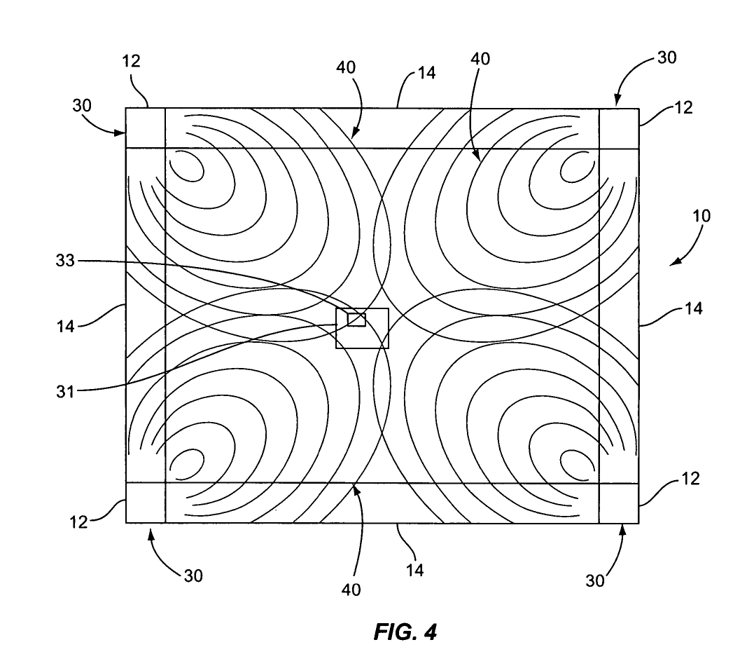

FIG. 4 illustrates an example of a pallet reader 30 and its communicaiton with an identification device 33 that would normally be attached to a good or article to be tracked when placed inside or moved from the pallet 10. A good or article containing an identification device 33, in the form of a RFID in this example, is placed inside the pallet 10. Each pallet reader 30 sends a signal 38 radiated in a field 40 using its antenna 36 having a given range based on design, frequency, and power. If the identification device 33 is in range of the field 40 generated by the antenna 36 of one of the pallet readers 30, the pallet reader 30 will interrogate the identification device 33 to receive the unique identification code for the article containing the identification device 33. In this manner, the pallet reader 30 identifies an article in the pallet 30. Because the pallet reader 30 is attached to the pallet 10, the pallet reader 30 can continue to interrogate the identification device 33 continuously and in real-time. Thus, the good having the identification device 33 is always tracked during the transport of the pallet 10, and the pallet reader 30 can determine if and when the article 30 is removed from the pallet 10.

It is noted that attaching the pallet reader 30 to the pallet 10 exhibits certain signal transmission properties that are important to the present invention. Since the pallet 10 comprises metal posts 12 and possibly metal meshing 24, in certain embodiments, the reflective properties of the metal tend to limit the range of the transmitted signal from the pallet reader 30 and/or the identification devices 33 so that these signals remain mostly within the confines of the pallet 10. This significantly reduces the possibilities of detecting identification devices 33 from adjacent pallets 10, or identification devices 33 that are near, but not contained within the pallet 10 of the attached pallet reader 30. However, the fact that the reflective properties of the metal limit the range of the transmitted signals from the pallet reader 30 and/or the identification devices 33 also requires one to consider the type of identification devices 33 necessary to meet the scope of the present invention. If the transmit power of the pallet reader 30 and identification device 33 is too strong, it may allow detection of identification devices 33 outside the specified pallet 10 and/or fail to meet regulation standards of various countries. On the other hand, if the transmit power of the pallet reader 30 and identification devices 33 is too weak, detection of all the identification devices 33 within the pallet 10 may be compromised. Therefore, the choice of the transmit power of the pallet reader 30 and type of identification devices 33 discussed below, must be adequately chosen depending on the metallic properties of the pallet design. Thus, unlike present belief that metal has only negative effects on transmitted signals, the metallic properties of the pallet 10 in the present invention are an important element that properly reflects and contains transmitted signals.

One example of the attached pallet reader 30 includes the iPAQ Pocket PC H3830 with Mantis PC Card Reader Pt# 10001570-23b, which was used when active identification tags 33 were implemented, and is incorporated herein by reference. The power rating for this RFID-type reader was set to a power setting of 2 on a scale of 10 for transmit power, therein providing enough transmit power to detect goods and materials within the designated pallet 10, but not too strong wherein external goods and materials were improperly detected. It is noted that the construction of the pallet and transmit power of the pallet reader 30 are not limited to this embodiment, and can be designed using other types of RFID-type readers, metal, and power settings to meet the scope of the invention, as described above.

When the pallet 10 of the present invention is enclosed, such as by the mesh sidings 24 and base 20 described in FIG. 2B, it may be preferred that the pallet reader 30 be attached to a corner post 12 near a limited access point, such as a low mesh siding 26 or through an opening at the top of the pallet 10. In this manner, the pallet reader 30 will be more likely to detect items containing an identification device 33 as they pass through a known transmission/reception range of the pallet reader 30 when the items are put into or taken out of the pallet 10. Therefore, limiting the access point of the pallet 10 can increase the likelihood that the identification device 33 will be detected when an item is placed and/or taken from the pallet 10, thereby increasing the reliability of the present invention.

Additionally, since there may be more than one pallet reader 30 provided, and because the fields generated by the pallet readers may overlap, the pallet reader 30 may be equipped with solutions to solve this problem of collisions caused by more than one reader 30 communicating with identification devices 33. For example, the pallet reader 30 may include anti-collision software that eliminates multiple detection of the same identification device 33. Examples of anti-collision RFID reader systems are described in U.S. Pat. Nos. 6,848,416; 6,812,838; 6,411,199; 6,392,544, all of which are incorporated by reference herein in their entireties.

Another solution to prevent issues from multiple reads of identification devices 33 by the same pallet reader 30 in the case of multiple pallet readers 30 is to designate one pallet reader 30 as the “master” reader, and the remaining readers 30 as the “slave” readers. The slave readers 30 communicate with the master reader 30 when an identification device 33 detected. Thereafter, the master reader 30 determines if it or another slave reader 30 previously detected the same identification device 33. If so, the master reader 30 informs the slave reader 30, and the slayer reader 30 ignore the detection.

Even another solution to prevent issues from multiple reads of identification devices 33 by the same pallet reader 30 in the case of multiple pallet readers 30 is to provide a multi-frequency solution, whereby the readers 30 are able to communicate with multiple identification devices 33 using multiple frequencies or slights variations of a common frequency. Examples of a multi-frequency RFID systems are described in U.S. Pat. Nos. 6,745,008; AND 6,693,512; both of which are incorporated by reference herein in their entireties.

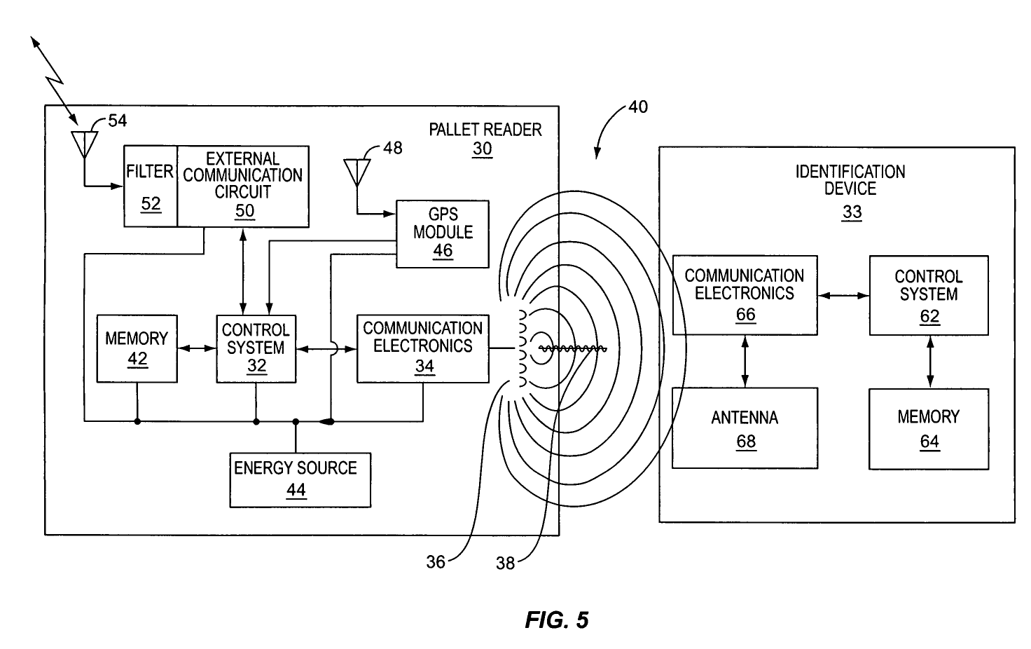

FIG. 5 illustrates the internal components of the pallet reader 30 in accordance with one embodiment of the present invention and an example of communication between the pallet reader 30 and an identification device 33, also known as a wireless communication device and/or RFID. The identification device 33 is a wireless identification device that is capable of communicating information, such as an identification code, wirelessly. The identification device 33 may include a control system 62, communication electronics 66, and memory 64. The communication electronics 66 is coupled to an antenna 68 for wirelessly communicating information in radio-frequency signals. The communication electronics 66 is capable of receiving modulated radio-frequency signals through the antenna 68 and demodulating these signals into information passed to the control system 62. The antenna 68 may be any type of antenna, including but not limited to a pole or slot antenna. The antenna 62 may be internal or external to the identification device 33.

The control system 62 may be any type of circuitry or processor that receives and processes information received by the communication electronics 66, including a micro-controller or microprocessor. The identification device 33 may also contain a memory 64 for storage of information. Such information may be any type of information about goods, objects, or articles of manufacture, including but not limited to identification, tracking, and location information. The memory 64 may be electronic memory, such as random access memory (RAM), read-only memory (ROM), flash memory, diode, etc., or the memory 64 may be mechanical memory, such as a switch, dip switch, etc. Further, the communication electronics 66, control system 62, and memory 64 may be integrated into a single integrated circuit (IC) or chip.

The present invention may be used with either an “active”, “passive”, or “semi-passive” identification devices 33. Some identification devices 33 are termed “active” devices (active RFIDs) in that they receive and transmit data using their own energy source. An identification device 33 may include its own battery for power as described in U.S. Pat. No. 6,130,602 entitled “Radio frequency data communications device,” or may use other forms of energy, such as a capacitor as described in U.S. Pat. No. 5,833,603, entitled “Implantable biosensing transponder.” Both of the preceding patents are incorporated herein by reference in their entirety. Typically, active RFIDs are able to achieve longer-range communication because they are not reliant on power from the RF signal communicated by the pallet reader 30 for power. Thus, each active RFID may be able to communicate its presence without having to pass through a detection field of the pallet reader 30 in order to be activated and detected. In this manner, if the identification devices 33 are active RFIDs, they are designed to actively transmit to and communicate with the pallet reader 30 regardless of whether it is within the pallet readers 30 reading field, thereby reducing the power requirement of the pallet reader 30. On the other hand, active RFID are more expensive and tend to be too large for certain type of stock. The increased cost of active RFIDs stems from the fact that they are geared toward more complex implementations that usually require an on-board processor and increased memory sizes to actively track and record data related to the goods or materials they are attached to, therein lending themselves to be more data intensive. Even with the added expense and complexity, active RFIDs may be preferred when the present invention is implemented in tracking systems that require complex tracking features and/or longer-range communication. An example one such active RFID is the SaviTag ST-654 High Performance Tag made by Savi Technology©, which is incorporated herein by reference.

Other identification devices 33 are termed “passive” devices (passive RFIDs) meaning that they do not actively transmit and therefore may not include their own energy source for power. One type of passive wireless communication device 10 is known as a “transponder.” A transponder effectively transmits information by reflecting back a received signal from an external communication device, such as an interrogation reader, also called “backscatter” communication. An example of a transponder is disclosed in U.S. Pat. No. 5,347,280, entitled “Frequency diversity transponder arrangement,” incorporated herein by reference in its entirety. Although passive RFIDs are typically cheaper than their counterpart active RFIDs described above, they can be more susceptible to failed reads due to shorter read distances. As discussed above, these shorter read distances may be contributed to the metallic material of the pallet 10, which can result in decreased performance of the present invention when passive devices are implemented. As a result of the shortened read distances, implementing passive RFIDs may be more reliable when the pallet 10 contains a designated area where goods or items are loaded and unloaded. In this manner, the area of entrance and exit for goods or materials of a pallet 10 is reduced in order to shorten the distance from the pallet reader 10, hence the read field, to the passive RFID located on these goods or materials, thereby increasing reliability the identification device 33 detection. Although implementing certain passive RFID technologies may allow read distances to become less orientation specific, truly passive RFIDs are typically beneficial when factors such as complexity and read distance are not as important as overall implementation costs.

Yet still another type of identification device 33 is known as a “semi-passive” device (semi-passive RFID) meaning that the antenna in the identification device 33 is used for two-way communication, and an energy source is provided for transmissions as well as using energy received from the magnetic field of the pallet reader 10. Exemplary semi-passive RFIDs include PowerID from Power Paper® and those made by Intelliflex. Like the passive RFIDs, the communication is principally backscatter type communication. However, by incorporating an energy source, such as a battery, the read distance of semi-passive RFID is increased as compared to the above discussed passive RFID, thereby improving the overall performance, hence detection, of the identification device 33 attached to the good or material. This increased read distance will also provide greater flexibility in the design of pallet 10, because the read distance will not be as significant of a factor. Although the addition of the battery in a semi-passive RFID adds some cost as compared to truly passive RFIDs, the semi-passive RFIDs are still typically less expensive than active RFIDs. Therefore, the use of a semi-passive RFID may be used as an alternative to the active RFID and passive RFID devices described above when there is a greater need for the combination of overall reliability and implementation costs.

While the present invention may be explained by example in terms of a passive RFID identification device 33, the present invention is not limited to any particular type of identification device, and the present invention is also applicable for use with semi-passive RFID and active RFID identification devices when applicable. Operating frequencies of the identification device 33 are not limited to any particular frequency, but UHF frequencies (300 MHz to 2400 MHz) may be best suited since these frequency ranges include frequencies that are permitted for use in private, non-government communication systems. Other RFIDs, such as those designed by SAVI Technology©, may be activated or notified of their position using a short-range low frequency (LF) link in the kHz frequency range. Thus, a variety of frequency bands and wireless communication standards may also be implemented in order to meet the scope of the present invention.

In an exemplary experiment, scaffolding parts containing identification devices 33 were sequentially moved from being positioned at roughly the same distance outside the pallet 10 to being placed inside the pallet 10 of the present invention in order to demonstrate that the pallet reader 30 would read those identification devices 33 positioned within the pallet 10 more reliably than when they were positioned otherwise. In this manner, 100 scaffolding parts were tagged with active RFIDs, and a pallet reader 30, the exemplary iPAQ Pocket PC H3830 with Mantis PC Card Reader Pt# 10001570-23b, was attached to a corner post of the pallet 10 and set to a power setting of 2 out of 10. Scaffolding parts containing identification devices 33 were moved from outside the pallet 10 and placed onto the pallet 10. The pallet reader 30 automatically recorded information relating to all of the identification device 33 of each scaffolding part placed within the pallet 10, but failed to record all the identification devices 33 when positioned outside the pallet 10. The final count of identification devices 33 was then transmitted to a host computer via wired and wireless communication techniques, which are further explained below.

FIG. 5 also depicts communication between an identification device 33 and the pallet reader 30 as an example. The pallet reader 30 includes a control system 32, a communication electronics 34, memory 42, and an antenna 36. The antenna 36 may be any type of antenna, including a pole antenna or a slot antenna. The antenna 36 may be internal or external to the pallet reader 30. The pallet reader 30 may also contain its own internal energy source 44, or the pallet reader 30 may be powered through an external power source. The energy source 44 may include batteries, a capacitor, solar cell or other medium that retains energy. The energy source 44 may also be rechargeable. Again, like the identification device 33, the communication electronics 34, control system 32, and memory 42 of the pallet reader 30 may be integrated into a single integrated circuit (IC) or chip.

The pallet reader 30 communicates with the identification device 33 by emitting an electronic signal 38 modulated by the communication electronics 34 through the pallet reader antenna 36. The antenna 36 may be any type of antenna that can radiate a signal 38 through a field 40 so that a reception device, such as the identification device 33, can receive such signal 38 through its own antenna 68. The field 40 may be electro-magnetic, magnetic, or electric. The signal 38 may be a message containing information and/or a specific request for the identification device 33 to perform a task, or simply to communicate back information to the pallet reader 30 including a unique identification code stored in memory 64 of the identification device 33. When the antenna 68 is in the presence of the field 40 emitted by the pallet reader 30, the communication electronics 66 are energized by the energy in the signal 38, thereby energizing the identification device 33 since the identification device 33 illustrated in FIG. 5 is a “passive” type device. The identification device 33 remains energized so long as its antenna 68 is in the field 40, also called “view,” of the pallet reader 30. The communication electronics 66 demodulates the signal 38 and sends the message containing information and/or request to the control system 62 for appropriate actions. Typically, this is simply to retrieve the unique identification code for the identification device 33 stored in its memory 64 and to communicate this code back to the pallet reader 30 for identification and tracking purposes.

It is readily understood to one of ordinary skill in the art that there are many other types of wireless communications devices and communication techniques than those described herein, and the present invention is not limited to a particular type of identification device, technique or method.

Any type of RFID may be used as the identification device 33. For full-range commercial usage, however, it is desired that the identification device 33, of an RFID, have the following requirements and be designed to operationally last for at least five years.

Reading temperature range: −40 to +70° C. (−40 to +158° F.)

Storage range (non-reading) −51 to +95° C. (−60 to +203° F.)

Further, it is also desirable to provide an identification device 33 that is functional over the full range of UHF frequencies that are approved for use in most countries, which are 318 MHz, 433 MHz, the band of 860 MHz to 960 MHz, and 2400 MHz. For example, in North America, the nominal operating frequencies are 902-928 MHz, conforming to FCC Part 15.247. In Europe, the nominal operating frequencies are 865-868 MHz, conforming to EN 302-208-1. In Japan, the pending nominal frequencies are in the range of 948-956 MHz, conforming to the Radio Law of Japan.

The pallet reader 30 may also contain devices that allow external communication with other devices for sending and receiving information as needed. For example, one object of the present invention is for the pallet reader 30 to communicate the identification codes of successfully identified identification devices 33 to other computer systems for tracking and reporting purposes in real-time, which will be described in more detail below in this application. Therefore, it is necessary to provide some means by which the pallet reader 30 can communicate externally with other systems.

As illustrated in FIG. 5, the pallet reader 30 may contain an external communication circuit 50 that is coupled to the control system 32. The external communication circuit 50 may include a filter 52 that is coupled to an antenna 54. The antenna 54 is tuned to receive signals of a desired frequency and to couple these signals to the filter 52, if present. After the signal is filtered by the filter 52, the signal is passed to the external communication circuit 50 where it is deciphered and communicated to the control system 32. Likewise, in return, the control system 32 may desire to respond or communicate externally. The control system 32 can communicate a message to the external communication circuit 50, which in turn radiates the signal out through the antenna 54. This communication may be desired to communicate identification codes of identification devices 33 that are successfully detected by the pallet reader 30.

The external communication circuit 50 may be any type of wire or wireless based and range based communication circuit including but not limited to universal serial bus (USB), Bluetooth and 802.11 type wireless communication transceivers. Examples of USB, Bluetooth and 802.11 communications are disclosed in U.S. Pat. Nos. 7,020,851, 6,717,516; 6,650,225; and 6,822,652, all of which are incorporated herein by reference in their entireties.

Note that an alternative design to the pallet reader 30 containing external communication ability, other than reading and communicating with identification devices 33, would be for the pallet reader 30 to store detected identification codes from identification devices 33 on articles or goods 31 on a pallet identification device 90 illustrated as attached on the pallet 10. The pallet identification device 90 is a RFID or other identification device attached to a corner post 12 that uniquely identifies the pallet 10. When the pallet reader 30 communicates articles detected in the pallet 10 to another system, the pallet identifier stored on the pallet identification device 90 can also be communicated, so that the system is also aware of which pallet the article was detected from.

The pallet identification device 90 would have to contain its writeable memory. The contents of the pallet reader memory 42 containing detected identification codes could be downloaded to the pallet identification device 90 at certain intervals by pallet readers 30, or in real-time, which could reduce the size of memory 42 required to be used in the pallet reader 30 as a cost reduction, since the identification codes are stored elsewhere without the pallet reader 30 having to store such, other than temporarily.

Thereafter, the pallet identification device 90 could download the stored identification codes from the pallet reader 30 to another reader, such as through a portal or on a forklift truck for example, rather than the pallet reader 30 being required to communicate such information to another system directly.

Further, in order to achieve detailed information as to not only when an identification device 33 is detected and its code, it may also be desirable to track the location of the identification device 33 when identified. In this manner, the location of the goods or articles containing the identification device 33 can be determined, which may be used for tracking purposes. Since the pallet reader 30 is resident with the pallet 10, the location of the pallet reader 10 when it identifies a good or article is also the location of the identification device 33. Thus, it may be desirable to provide the pallet reader 30 with the ability to determine and communicate its geographic position by including a global positioning system (GPS).

As illustrated in FIG. 5, a GPS receiver 46 may be provided as part of the pallet reader 30. Because a GPS module typically communicates with a satellite at specific frequencies, a separate GPS antenna 48 will typically be required if GPS functionality is provided. The GPS module 46 is a receiver system that receives electronic signals containing positioning information representing the location of the pallet reader 30, hence the pallet 10 and the identification devices 30 contained therein. One example of a GPS receiver is described in U.S. Pat. No. 5,648,763, which is incorporated herein by reference herein in its entirety. The GPS receiver 46 receives signals from three or more satellites via antenna 48 and uses triangulation to determine its location. After the GPS receiver 48 receives information in order to determine its location, the GPS receiver 48 can transfer this information to the control system 32 by request of the control system 32. Thereafter, the control system 32 can store and/or transmit its location when identification devices 33 are read for communication to other systems to use as part of tracking algorithms and processes.

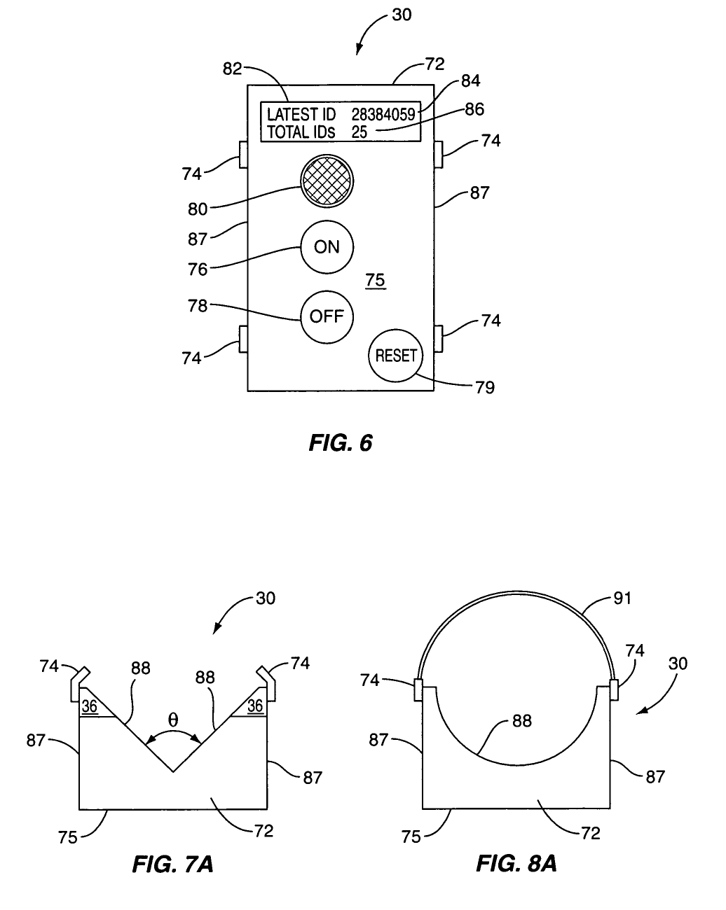

FIG. 6 illustrates more detail on one example of a pallet reader 30. The pallet reader 30 is contained with a housing 72, which is typically constructed out of plastic, such as DMC plastic, or any other rugged material. The housing 72 is typically not constructed out of a metallic or conductive material since the antenna 36 may be provided in the housing 72, and the metallic housing would interfere with pallet reader 30 communications. The front of the pallet reader 30 as shown includes clamps or clips 74 that are used to mount the pallet reader 30 to the pallet 10, and preferably the corner posts 12 as will be described in more detail below.

The pallet reader 30 illustrated in FIG. 6 includes a user interface 75 that provides visual information to an operator or user, and control buttons to control certain operations of the pallet reader 30. The user interface 75 contains an “ON” button 76 so that an operator or personnel servicing the pallet 10 can turn the pallet reader 10 on. Pressing the “ON” button 76 activates a switch to cause the energy source 44 to be connected to the internal components of the reader 30. As previously described above, the memory 42 in the pallet reader 30 may be flash memory or other non-volatile memory that is retained even when the pallet reader 30 is turned off. When the pallet reader 30 is turned on, by pressing the “ON” button 76, the pallet reader 30 can be configured to execute a power up routine in software in memory 42 that is executed by the control system 32 to determine if the identification codes previously identified and stored in memory 42 of the pallet reader 30 are still residing within the pallet 10. If not, the pallet reader 30 may erase those identification codes not present and report such to a docking station or other communication system as will be described below in more detail.

In turn, pressing the “OFF” button 78 causes a switch to decouple the energy source 44 from the reader 30 components to turn the pallet reader 30 off. A “RESET” button 79 may be provided to cycle power off and on in the event that there is a failure in the pallet reader 30 and/or its control system 32 in executing software to reset the system. A status LED indicator 80 coupled to the control system 32 may also be provided that provides a visual indication of the current status of the pallet reader 30 so that an operator can visually determine the status of the pallet reader 30 to ensure that the reader 30 is operating properly. A green color may indicate that the pallet reader 30 has just successfully interrogated the identification code from an identification device 33. A yellow color may indicate that the pallet reader 30 has not interrogated an identification device 33 or a new identification device 33 in a prescribed time after the last success interrogation of an identification device 33. A red color on the status indicator 80 may indicate an error condition in the pallet reader 30 so that an operator is notified that the pallet reader 30 is not operating properly.

A LCD display 82 is also provided that provides visual information regarding the identification devices 33 interrogated. As an example, the pallet reader 30 may indicate the identification code 84 of the last identification device successfully interrogated as well as the total number of identification devices 33 present on the pallet 30. In this manner, a person either putting articles inside the pallet 10 or removing articles from the pallet 10 can visually determine if the number of articles is correct and thus the pallet reader 30 has properly interrogated all articles placed inside or removed from the pallet 10.

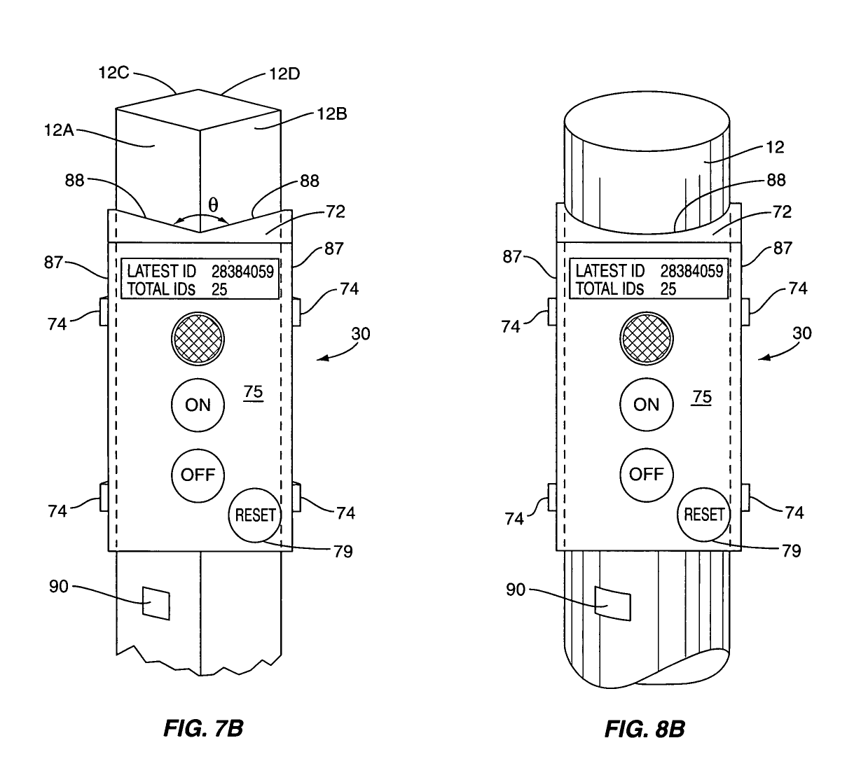

FIG. 7A illustrates one embodiment of a top view of the pallet reader 30 illustrated in FIG. 6 that is designed to be attached to a square shaped corner post 12 of the pallet 10. The housing 72 of the pallet reader is comprised of a front section 75, side portions, and a back portion comprising two substantially equidistant sections 88 that are placed inward and attached to form angle ‘Θ’ there between. Antennas 36 may be placed on the back side 88 inside the housing 72 so that the antennas 36 of the pallet reader 30 are placed closest to the internal portion of the pallet 10 where the goods having the identification devices 33 will be located and interrogated. Note that depending on design considerations, it may be necessary for the antenna 36 to be located closer towards the inside of the pallet 10 such that a housing 72 for the reader 30 is provided that encompasses a greater portion of the corner post 12 toward the inside of the pallet 10 in order to successfully interrogate identification devices 33. Alternatively, the reader 30 may be rotated so that the antenna 36 is pointed in the vicinity of the inside of the pallet 10 for the same purpose.

FIG. 7B illustrates the reader illustrated in FIG. 7A attached to the corner post 12 of the pallet 10. In order to attach the pallet reader 30 flush against the corner post 12, the angle ‘Θ’ is provided to be a complementary angle to the angle between two adjacent sections of the corner post 12. The reader 30 also illustrates the clips 74 that can be used to attach to the rear sides of the corner posts 12, from the perspective of the front of the reader 30, to physically secure the pallet reader 30 to the pallet 10.

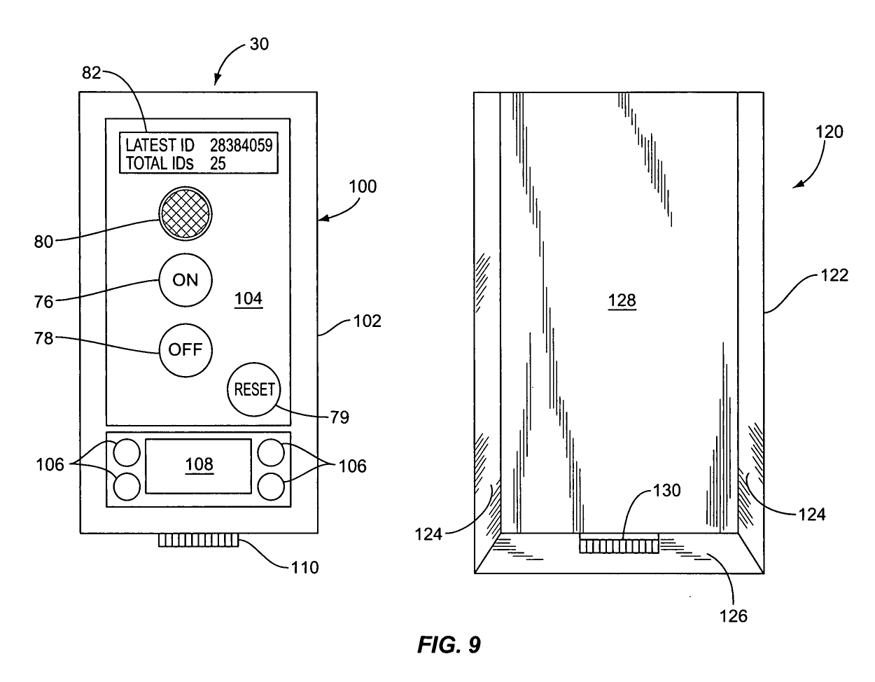

FIG. 8A illustrates an alternative embodiment of a top view of the pallet reader 30 illustrated in FIG. 6 that is designed to be attached to a cylindrical shaped corner post 16. The back portion 88 of the pallet reader 30 contains a substantially semi-circle shaped indention that is designed to fit securely against a cylindrical shaped corner post 12. Instead of clips 74, a strap 91 is connected to end pieces 74 connected to the housing 72 of the reader 30.

FIG. 8B illustrates the reader illustrated in FIG. 7A attached to the cylindrical shaped corner post 12 of the pallet 10.

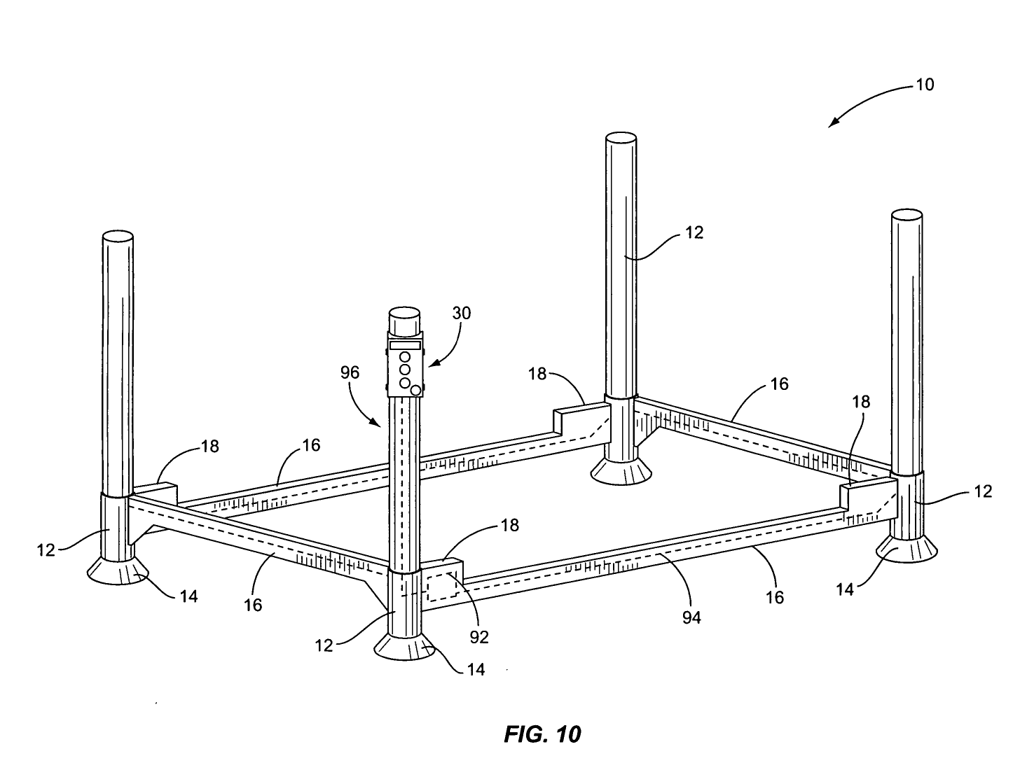

FIG. 9 illustrates a pallet reader 30 that is a removable and portable reader 100. For example, the portable reader 100 may be provided in the form of a personal digital assistant (PDA) having a housing 102 that contains a user interface 104 where the previously described input and output controls may be provided as illustrated. If the portable reader housing 102 is in the form of a PDA, various input control buttons 106 and an input pad 108 may also be provided. In this manner, an operator may be required to input an operator unique code or password in order to gain access to the portable reader 100 before beginning the loading/unloading process. This has the advantages of both securing the portable reader 100 from tampering by unauthorized personnel, and tracking which personnel are responsible for loading/unloading certain pallets, thereby allowing productivity to be recorded. The portable reader 100 would also contain an interface connection 110 so that the reader 30 can be inserted into a reader station 128, also illustrated in FIG. 9. The reader station 128 may be in the form of the housing 72 that was previously illustrated in FIGS. 6-8A. The reader station 128 contains a female interface 130 that accepts as an input the interface connection 110 of the portable reader 30 to connect the portable reader 30 to the reader station 128.

Also note that a similar configuration to that illustrated in FIG. 9 could be used for a pallet reader 30 to be attached to the pallet 10. For example, the reader station 128 would be provided as part of or attached to the pallet 10. The portable reader 100 in the form of the PDA, and more particularly the interface connection 110 would then be connected to the female interface 130 on the reader station 128. In this manner, the portable reader 100 would be connected to the pallet 10 in order to detect and inventory items containing identification devices 33 that are positioned therein.

Other designs are also possible to make it easy to connect the pallet reader 30 to the pallet 10 or a device connected to the pallet 10, which could include a computer card package, such as a SIM card for example, where the pallet reader 30 is in the form of a SIM card, and the SIM card reader 30 is inserted into a SIM card port that is either part of the pallet 10 construction or attached to the pallet 10.

In the preferred embodiment, the reader station 128 would contain the energy source 44, the interrogation communication electronics 34, and the antenna 36. This allows the portable reader 100 to be easily detached from the pallet 10 without disconnecting the physical reader station 128 from the pallet 10, so that the portable reader 100 can be connected to another docking station or computer to download information from memory 42 concerning the interrogated identification devices 33 that were placed inside or taken from the pallet 10, as will be described in more detail below.

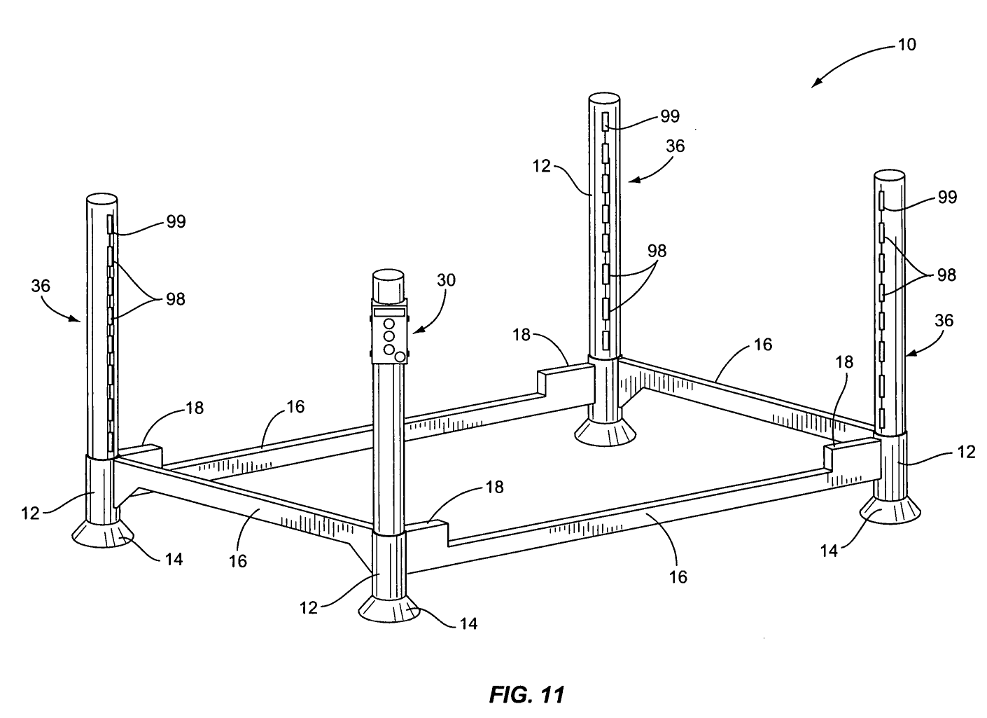

FIG. 10 illustrates the pallet 10 with an installed pallet reader 30 wherein the power source for the pallet reader 30 is provided externally as part of the pallet 10. This may be advantageous to reduce the size of the pallet reader housing 72 when more than one pallet reader 30 is included on the pallet 10, because each pallet reader 30 can share a common power source rather than requiring each pallet reader 30 to include its own self-contained power source.

As illustrated in FIG. 10, the pallet reader includes a power source in the form of a battery 92, which may be incorporated internally into the flaps 18 and/or side posts 16. The battery 92 is connected to other areas of the pallet 10 via a power line 94. In the embodiment illustrated in FIG. 10, the power line 94 is coupled to all parts of the pallet 10 via the side posts 16 and inside each of the corner posts 12 so that the pallet reader 30 can be coupled to the power line 94. An electrical connector or fitting (not shown) may be provided as part of the corner post 12 at the termination point of the power line 94 so that the reader 30 can be attached to the power line 92 by a connector provided on the reader 30 plugging in or being inserted by such connector or fitting. Also note that although the pallet 10 illustrated in FIG. 10 only contains one pallet reader 30, more than one pallet reader 30 may be provided and/or coupled to the power line 94. Further, if the side posts 16 can be taken apart and there is concern that the power line 94 will be severed as a result of taking apart the side posts 16 from the corner posts 12, each flap 18 can be provided with its own power source 92 for connection to a pallet reader 30 of its related corner post 12. Additionally, a connection fitting can be provided to couple the power lines 94 together and to the power source 92 when the side posts 16 are connected to their respective corner posts 12.

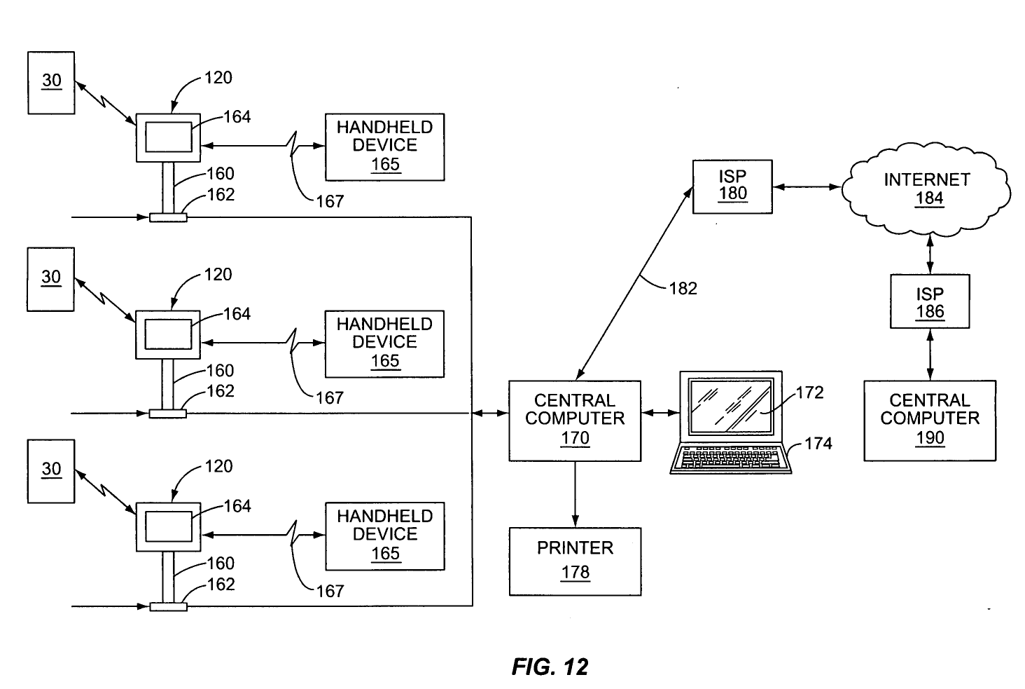

FIG. 11 illustrates the pallet 10 with an external antenna that may be used as the pallet reader antenna 36. It may be desirable to provide the antenna 36 external to the reader 30 and as part of the pallet 10 so that installation of the reader 30 does not affect the location of the antenna 36 and thus provides a more predictable antenna pattern that is created to successfully communicate with identification devices 33 contained inside the pallet 10. Further, providing the antenna 36 as part of the pallet 10 may prevent the pallet 10 components from interfering with the antenna 36 rather than if the antenna 36 is provided as part of the pallet reader 30.

As illustrated in FIG. 11, a series of slot antennas are provided in the corner posts 12 of the pallet 10 to provide the antenna 36 for the pallet reader(s) 30. The slot antenna 36 is provided using a plurality of slots 98 formed in the corner post 12 of the pallet 10. Only one slot 98 is required, but more than one slot 98 and slots 98 of varying sizes may be provided depending on performance characteristics and the range desired by the pallet reader 30. More information on slot antennas and their operation is described in U.S. Pat. No. 4,975,711, entitled “Slot antenna device for portable radiophone,” incorporated herein by reference in its entirety.

Slot antennas 36 may be particularly useful for the present invention, because a slot antenna allows an existing portion of the pallet 10 to be used for a dual purpose thereby reducing costs and reducing the need for a separate pole based antenna. The pallet reader 30 is attached to pallet 10 in such a manner that the communication electronics 34 of the pallet reader 30 are coupled to a slot 98 in the corner post 98. If more than one slot 98 is provided for a given slot antenna 36, the slots 98 are coupled together by a shunt to form one effective slot antenna 36.

When the communication electronics 34 of the pallet reader 30 applies voltage signals across the slot(s) 98, the slot(s) 98 radiate(s) electro-magnetic waves similar to the manner in which a pole antenna arrangement would radiate to effectuate communications. The radiation pattern of the slot antenna 36 is similar to a pole antenna arrangement, such as a dipole antenna, but the E and H fields are interchanged. While FIG. 11 illustrates an example of a slot antenna 36 as one method of providing the pallet reader antenna external to the pallet reader 30, please note that the a pole based antenna may be provided as the external pallet reader antenna 36 on the pallet 10 and the present invention is not limited to any particular type of external pallet reader antenna 36 being provided on the pallet 10.

Communication Architecture Example

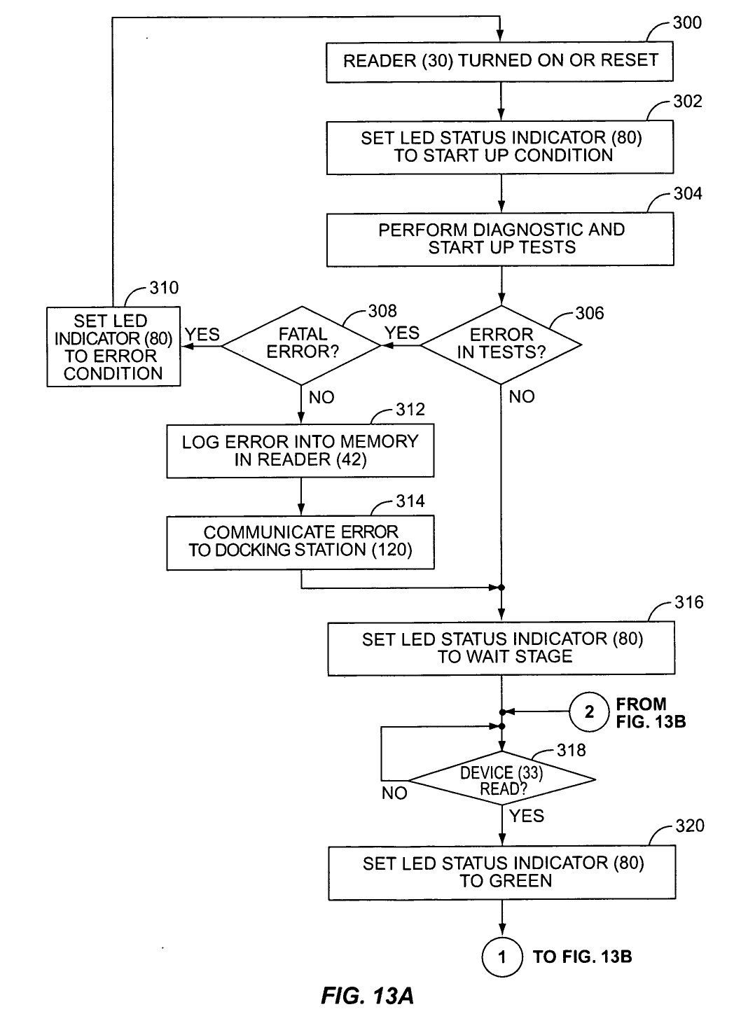

FIG. 12 illustrates a communication architecture that may be used in the present invention for the pallet reader 30 to communicate information concerning identification devices 33 interrogated to a central computer or facility computer that can in turn provide inventory control and other features as described below. This allows the identification codes detected by the pallet reader 30 to be communicated in real-time, thus totally eliminating the disconnect between the detection of the identification devices 33 and computer records use to track and provide a real-time inventory of the identification devices 33.

As previously discussed, the pallet reader's 30 function is to communicate with identification devices 33 on goods or articles contained in the pallet 10 for storage and/or transport. After the pallet reader 30 successfully detects an identification device 33, the code of the identification device 33 is typically stored in memory 42 of the pallet reader 30. As illustrated in FIG. 12, the pallet reader 30 may be adapted to communicate information regarding identification of identification devices 33 to other systems. As discussed above and illustrated in FIG. 10, the pallet reader 30 may be designed to be removable from the pallet 10 or its housing 72 in whole or part. In this manner, the pallet reader 30 can be connected via physical connection to a docking station or other system that is capable of downloading information regarding detection of identification devices 33 stored in the pallet reader's memory 42 in order to keep track of inventory related to goods and/or materials containing identification devices 33 on a specific pallet 10. Downloading this information can be accomplished by docking the pallet reader 30, such as the previously discussed portable reader 100, into a USB coupled cradle, which is adapted to synchronize the detected identification device 33 information with the docking station 120 or other system capable of downloading the detected information. However, it may also be desirable to allow for the pallet reader 30 to wirelessly communicate information to other systems without removal or displacement of the pallet reader 30 via Bluetooth, 802.11, or other wireless transmission standards. As previously discussed, the pallet reader 30 may contain communication circuitry/transceiver that allows communication of information to external systems. FIG. 12 is an example of a communication architecture system, whereby the pallet reader 30 can communicate information regarding detection of identification devices 33 to other systems for real-time tracking and performing of algorithms on data regarding identification devices 33.

As illustrated in FIG. 12, one or more docking stations 120 are provided that are adapted to wirelessly communicate with the pallet readers 30. The pallet reader 30 may contain short-range or long-range communication capabilities. The docket station 120 may be provide in the form of a stand 160 with a base 162 containing a communication terminal containing communication circuitry and antennas (not shown). The docking station 120 may contain a user interface and display 164 so that service personnel can retrieve data received from the pallet readers 30 regarding detection of identification device 33. The docking stations 120 may be provided locally at a facility or more remotely where longer-range communications are used to communicate with the pallet readers 30.

Further, the docking station 120 may be adapted to communicate with a handheld reader 165 via a local communication signal 167 in the event that a solution is needed whereby both data from scanned identification devices 33 using both the pallet reader 30 as well as a handheld reader 165 can be downloaded into the docking station 120. The docking stations 120 may be communicatively coupled using wire or wireless, direct or indirect communication, to a facility or central computer 170. The central computer 170 may be coupled to a printer 178 for printing log reports of data concerning detection of identification devices 33 and a terminal in the form of a display 172 and keyboard 174 for programming and access to data in the computer 170, including but not limited to identification devices 33.

The facility computer 170 may be coupled to the Internet or other network via a dedicated or general communication line 182 to a service provider 180, which in the case of the Internet is an Internet service provider (ISP). The ISP 180 allows for communication traffic to be sent to and from the Internet 184 to other computers 190 which also may be coupled to the Internet or network via their own ISP 186. Again, this communication architecture may be provided so that data regarding identification devices 33 can be communicated beyond the pallet reader 30 to other systems for tracking, inventory, and algorithms to be executed regarding same.

Identification Device Data Structure

Any type of data structure may be used for the pallet reader 30 to store information and detection of identification devices 33 in memory 42. However, it may be desirable to use a data structure that is based on a common or standard specification so that the identification codes can be easily migrated with other systems that may use other types of identification devices or methods to record products or goods, such as a UPC code for example.

In one embodiment of the present invention, either an EPC Global or Department of Defense (DoD) 96-bit data structure is to be used. The EPCglobal tag data standards. Or, if the application has defense applications, the DoD data structure may be used which is as follows:
UID Unit Pack: Used on item packaging meeting the DoD criteria for assignment of UID.
DoD Case or Pallet: Items shipped as either pure or mixed case or pallet

The DoD 96-bit data structures are constructed as follows:

| Header | Filter | DODAAC/CAGE | Serial Number |
|---|---|---|---|
| 8 bits | 4 bits | 48 bits | 36 bits |

Header: Application Function Identifier (AFI) header value CFheX (binary value 1100 1111) compliant with ISO 15691 indicating that this is a DoD-defined tag data structure
Filter: Identifies whether the object is a pallet, case or UID-identified item:
   0000—Pallet
   0001—Case
   0010—UID identified item
   All other 4-bit combinations are reserved
DODAAC/CAGE: Six 8-bit ASCII characters that identify the supplier and ensure uniqueness of serial number across all suppliers.
Serial Number: Thirty-six bit binary serial number that identifies up to 6 8,719,476,736 unique items.
   Identification Device Counting and Tracking

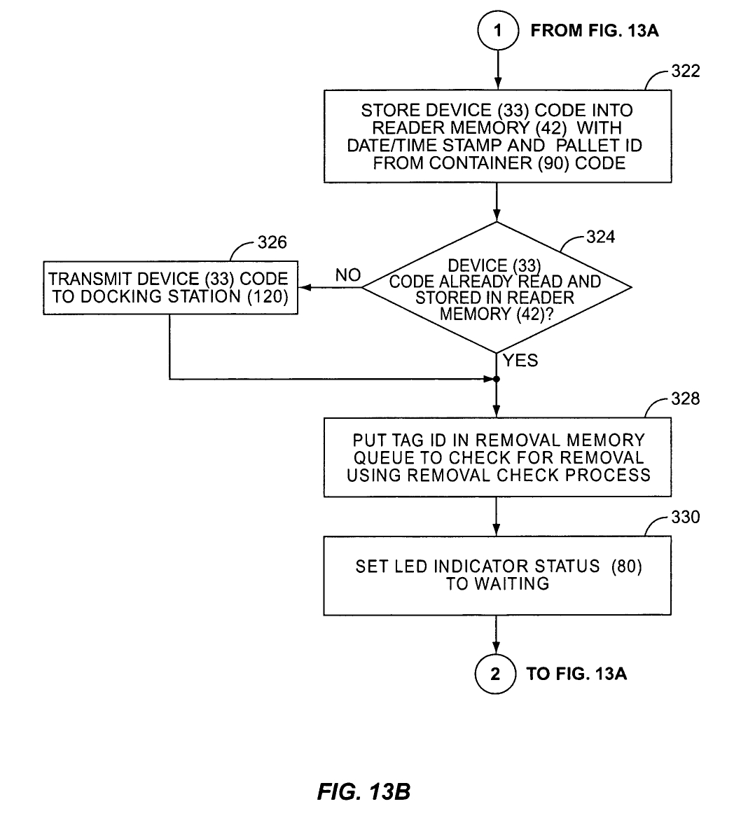

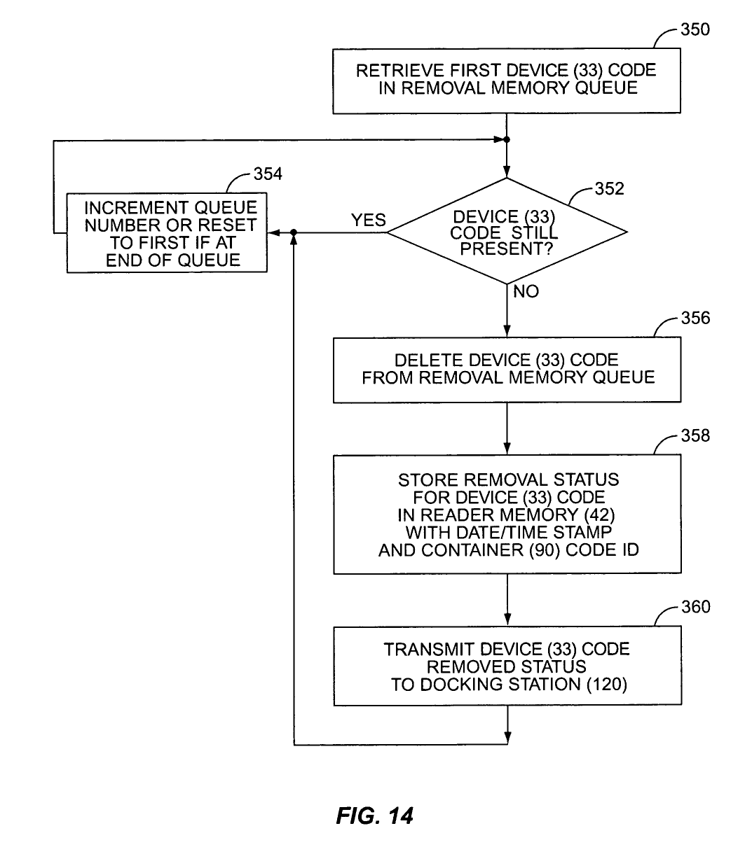

Until this point, the present invention has been discussed in terms of identification devices 33 and pallet readers 30 that communicate with each other, and supporting hardware and communication architectures. During operation of these various devices, the goal in accordance with the example of the invention disclosed in this application is to track goods or articles of manufacture containing identification devices 33 as they are put inside or taken from the pallet 10 in real-time as a form of an audit trail. The pallet reader 30 may perform these algorithms, or they may be performed by the docking station 120 and/or central computer 170 since the pallet reader 30 has the ability to communicate information regarding identification devices 33 detected to these systems. An example of tracking identification devices 33 inserted and removed from the pallet 10 is disclosed in the flowcharts illustrated in FIGS. 13A-14, discussed below. It should be noted that tracking of identification devices 33 using the pallet reader 30 may be accomplished in numerous ways, and the present invention is not limited to any particular technique or method.

After the pallet reader 30 is installed on the pallet 10 and is turned on or reset (step 300), the pallet reader 30 sets the LED status indicator 80 to a start-up condition, which may be represented by a particular color identifiable to an operator (step 302). Thereafter, the pallet reader 30 may perform internal diagnostic and startup tests that are typical (step 304). For example, if the pallet reader 30 wants to determine if it is able to properly read an identification device, it may read an identification device 90 that is provided as part of the pallet 10 and is so identified as a test.

If a test fails (decision 306), the pallet reader 30 may next determine if the error is fatal (decision 308). If so, the pallet reader 30 may cause the LED status indicator 80 to indicate an error or fault condition using a particular color, and the process repeats until the reader 30 is reset or turned on (step 300). If there was an error, but the error was not fatal or will not prevent operation of the pallet reader 30 for detection of identification devices 33, the pallet reader 30 may log the error into memory 42 (step 312), communicate the error to a docking station 120 (step 314), and continue as normal as if there were no errors during startup (step 316).

Whether there were not errors during startup or no fatal errors that would prevent operation of the pallet reader 30, the pallet reader 30 may cause the LED status indicator 80 to indicate a wait stage, which is the state when the pallet reader 30 is waiting to read a next identification device 33, and then wait until an identification device 33 is successfully read (decision 318). Once the pallet reader 30 successfully detects an identification device 33, the pallet reader 30 may change the LED status indicator to indicate a successful read for feedback to the user if the user is located near the pallet reader 30 and pallet 10 where placing articles therein (step 320) occurs. This also allows a user to verify that each article placed in the pallet 10 or removed from the pallet 10 was successfully detected by the pallet reader 30.

The example provided herein assumes that although the identification devices 33 in the pallet 10 are constantly/continuously detected by the pallet reader 30, the more important determination is made when a new identification device 33 is detected that was not previously detected or vice versa. These changes indicate new articles that are placed in the pallet 10 or removed, and thus are relevant to the overall tracking of goods or articles. So, after the pallet reader 30 reads an identification device 33 successfully, the pallet reader 30 stores the identification code of that device 33 into memory 42, possibly with a date and time stamp and/or the pallet identification code that is either hard coded in the pallet reader 30, or read from the pallet identification device or tag 90 (step 322). The pallet reader 30 next compares the identification code just detected to identification codes stored in memory 42 (decision 324). If the identification code is not already stored in memory 42, meaning that the article is being detected by the pallet reader 30 for the first time or since the article was last removed, the pallet reader transmits the identification code to the docking station 120 or other computer systems to report (decision 326) the detected identification code.

If the identification code from the identification device 33 just read was already present in memory 42, meaning that the identification device is already in the pallet 10 and the detection by the pallet reader 30 is a re-read, or the identification device 33 was detected for the first time, the reader 30 places the code of the identification device 33 into a removal queue so that the reader 30 can continue to check to ensure that the identification device 33 continues to be identified by the pallet reader 30. If the identification code of a previously read identification device 33 is not read within a prescribed amount of time after first being detected by the pallet reader 30, this is an indication that the identification device 33 and thus the articles it was attached to have been removed from the pallet 10. The LED status indicator 80 is next set to a waiting status, and the process returns back to step 318 to wait until the next identification device 33 is successfully read. A separate process is executed to determine if the identification device codes in the removal queue continue to be detected and thus the article containing the identification device 30 has been removed. This process is illustrated in FIG. 14.

As illustrated in FIG. 14, the process begins by the pallet reader 30 or other computer system that receives information about identification codes read by the pallet reader 30, retrieving the first identification code in the removal memory queue (step 350). Thereafter, the process determines if the identification device 33 is still present by waiting for a prescribed period of time to determine if the identification code for the identification device 33 has been detected (decision 352). If so, this means that identification device 33 is still in the range of the pallet reader 30 and thus is still present in the pallet 10. In this manner, the queue number is incremented to check for the next identification code in the removal memory queue (step 354), and the process repeats by returning to step 352.

If the identification code was not successfully detected by the pallet reader 30 in the prescribed amount of time (decision 352), this is an indication that the article containing the identification device 33 has been removed form the pallet 10. The identification code or tag ID is removed from the memory queue (step 356), the removal status is stored in memory 942) with a date and time stamp so that the reader 30 stores that the identification device 33 has been removed and when (step 358), and the identification code may be transmitted to the docketing station 120 or other computer to indicate its removal from the pallet 10 (step 360). Thereafter, the process repeats by returning to decision 352.

Addition/Subtraction System Example

The system described above provides a more accurate system of determining when an article having an identification device 33 is added or removed from a pallet 10. However, the system does not track a gross error for the situation where the number of articles removed from the pallet 10 is greater than the number of articles detected as being added to the pallet 10, and thus an error occurred in the reader 30 not properly detecting an article placed in the pallet 10 properly when added or after added. Note that the pallet reader 30 can still detect items even after they are added to the pallet 10, such as if the articles have shifted to be in the range of a reader 30. Again, the pallet readers 30 should be arranged so that there are no “blind spots” in the pallet 10 and an article having an identification device 33 is always detected in the absence of any actual system errors that may occur.

The pallet reader 30 could employ an addition and subtraction system, whereby the pallet reader 30 generates an alarm or error condition either on the LED status indicator 80, or by communicating such externally via remote communications, if the number of articles removed from the pallet 10 is ever greater than the number of articles detected as being added to the pallet 10. This system does not provide real-time error tracking, but simply detects an error when the pallet 10 is emptied and the number of items emptied is greater than those that were placed in the pallet 10, meaning that one of the identification codes was not properly tracked. However, this system, by tracking the identification codes, can detect when an article and its identification code was not properly detected when added to the pallet 10, but was detected when removed.

Scaffolding Applications

As discussed above, it may be desirable to employ the present invention for tracking and detection of scaffolding materials transported by pallets 10 or other containers. However, not all parts lend themselves easily to attachment of identification devices 33, such as RFIDs, to the article. The geometry of the article can be such that does not lend itself to attachment of an identification device 33, or the identification device 33 would interfere with the intended function of the device. This is particularly an issue for putting identification devices 33 on parts, where the parts must be functional as part of the ordinary use, like scaffolding parts for example.

Another problem that exists with placing of identification devices 33 on goods is environmentally sealing the identification device 33 from the environment. Since the identification device 33 often includes electronic circuitry, it is important that moisture or liquids do not easy reach the identification device 33 when installed on the part or article of manufacture.

Also, parts or articles are constructed out of a metallic material that when the identification device 33 is attached, the metallic material interferes with communication, like the present scaffolding parts. The metallic material causes reflections that alter the electro-magnetic field sent by the pallet reader 30 towards the identification device 33, thereby interfering with the return backscatter communication that is often used in “passive” and “semi-passive” identification devices. Therefore, the present invention also includes an identification device capsule that is particularly suited for solving all of the aforementioned problems and is particularly useful for cylindrical metal parts that are common components of many parts, including but not limited to scaffolding parts.

Thus, it may be desirable to employ some additional features and aspects of the invention for such parts, including but not limited to scaffolding parts.

Clamshell Enclosure

In order to provide a protective housing for an identification device 33 and to provide for easy replacement of identification devices 33 as new and/or improved devices are made available or desired to be used, the identification device 33 could be inserted into an enveloping clamshell type device as a way of applying. The clamshell should preferably be watertight once sealed. The clamshell adhesives should preferably allow for initial tack and harden with time. A two part adhesive would be suitable for the clamshell type device. The type of plastic used for these clamshells should be both transparent to UHF radio waves and UV-resistant. Most types of high density polypropylene and high density polyethylene could be used as reasonable materials where attenuation at UHF frequencies is not significant. Polyvinyl Chloride (PVC) films should be avoided due to potential long-term chemical corrosion issues with transponders utilizing copper antennas.

Adhesives

An adhesive may be used to mount the identification device 33 to parts, including scaffolding parts. If an adhesive is used, it may be desired to take into consideration two sets of properties that adhesives contain. The first is called “initial tack” (i.e. the ease of initial adhesion) and the second is called the “settling time” (i.e. the number of minutes or hours it takes to form the full-strength permanent bond). Most adhesives are primarily selected for the second set of properties. There are two basic adhesive families: Acrylic adhesives and rubber-based adhesives. Two part adhesives, containing a resin and accelerator, may be used for attachment of identification devices 33 to parts or goods.

Since an adhesive may be a complex chemical mixture and may also be in direct contact with the identification device 33 antenna, the adhesive can have strong effects on performance of the identification device 33 in that the adhesive may absorb RF energy. Chemical constituents of the adhesive may have a corrosive affect on the identification device 33 antenna (especially etched copper antennas). Also, many adhesives tend to chemically deteriorate with age so that while the adhesive properties may be perfectly acceptable at the time of initial RFID-enabled label application for the identification device 33, after several months or years the effects of adhesive aging may affect the performance in terms of range of the identification device 33.

Capsule Design for Cylindrical Parts/Scaffolding.

For cylindrical shaped materials, other enclosures may be used that not only allow secure attachment of the identification device 33 to the material, but also provide insulation to keep the material from interfering with the identification device 33.

More information regarding scaffolding RFID and identification device asset-based tracking systems is provided in Exhibit A to this application entitled “Scaffolding RFID Asset Tracking System,” which is incorporated herein by reference in its entirety.

Those skilled in the art will recognize improvements and modifications to the preferred embodiments of the present invention. All such improvements and modifications are considered within the scope of the concepts disclosed herein and the claims that follow.

We claim:

1. A system adapted to track items employing an electronic identification device, comprising:
a pallet adapted to hold one or more of the items; and
a reader coupled to the pallet and adapted to:
respond to an identification field within the pallet; and
detect an electronic identification device coupled to each of the one or more items when the one or more items are placed into the identification field.

2. The system of claim 1, wherein the reader is further adapted to:
store identification information corresponding to the electronic identification device in memory associated with the reader;
wherein the memory contains a record of the identification information of all the electronic identification devices contained within the pallet at a given time.

3. The system of claim 1, wherein the pallet comprises a metallic material, and the identification field is partially formed as a result of identification signals reflecting off of the metallic material.

4. The system of claim 1, wherein the identification field is generated by a device from the group consisting of the electronic identification device and the reader.

5. The system of claim 1, wherein the pallet comprises mesh siding attached to a base of the pallet in order to surround the one or more items placed therein.

6. The system of claim 1, wherein the pallet comprises at least one corner post attached to a base, thereby creating an entry point that limits the area where the one or more items can be added and removed from the pallet.

7. The system of claim 6, wherein the at least one corner post is a post comprised from the group consisting of a square post and a tubular post.

8. The system of claim 6, wherein the at least one corner post further comprises an antenna integrally formed therein and coupled to the reader when the reader is coupled to the pallet to detect the electronic identification device.

9. The system of claim 6, wherein the reader is coupled to the at least one corner post proximate the entry point to detect the electronic identification device when the one or more items are added and removed from the entry point of the pallet.

10. The system of claim 6, wherein a power line is integrally formed within the at least one corner post and is coupled to the reader to provide power to the reader when the reader is coupled to the pallet.

11. The system of claim 1, wherein the reader is further adapted to be removable from the pallet.

12. The system of claim 1, wherein the reader is coupled to a docking station that is coupled to the pallet in order to couple the reader to the pallet, wherein the reader is removable from the docking station.

13. The system of claim 1, wherein the reader is further adapted to transmit the record of the identification information to a system comprised from the group consisting of a docking station, a central computer, and a database.

14. The system of claim 1, wherein the identification device is a device comprised from the group consisting of an active identification device, a passive identification device, and a semi-passive identification device.

15. The system of claim 1, wherein the reader is further adapted to store, in memory associated with the reader, information about the identification device comprised from the group consisting of date information, time information, and pallet ID information when identification information corresponding to the electronic identification device is stored.

16. The system of claim 1, wherein the reader is further adapted to indicate a removed status corresponding to the electronic identification device when the electronic identification device coupled to each of the one or more items is removed from the pallet, thereby tracking the one or more items contained within the pallet at a given time.

17. The system of claim 16, wherein the reader is further adapted to include status information about the electronic identification device comprised from the group consisting of date information, time information, and pallet ID information as part of the removed status when the identification device coupled to each of the one or more items is removed from the pallet, thereby tracking the one or more items removed from the pallet at a given time.

18. A method of tracking items employing an electronic device, comprising the steps of:
responding to an identification field around a pallet adapted to hold one or more of the items when the reader is coupled to the pallet; and
detecting at the reader, an electronic identification device coupled to each of the one or more items when the one or more items are placed into the identification field.

19. The method of claim 18, further comprising the step of storing at the electronic reader, information related to the electronic identification device in memory coupled to the reader that contains a record of the information for all the electronic identification devices contained within the pallet at a given time.

20. The method of claim 18, further comprising the step of forming the identification field as a result of identification signals reflecting off metallic material of the pallet.

21. The method of claim 18, wherein the pallet comprises mesh siding attached to a base of the pallet in order to surround the one or more items placed therein.

22. The method of claim 18, further comprising the step of creating an entry point by attaching at least one corner post to the pallet, wherein the one or more items are added and removed from the pallet.

23. The method of claim 22, further comprising detecting the electronic identification device using a reader coupled to an antenna integrally formed in the at least one corner post.

24. The method of claim 22, further comprising detecting the electronic identification device using the reader coupled to the at least one corner post.

25. The method of claim 22, further comprising providing power to the reader by coupling the reader to a power line integrally formed within the at least one corner post.

26. The method of claim 18, wherein the reader is coupled to a docking station that is coupled to the pallet in order to couple the reader to the pallet, wherein the reader is removable from the docking station.

27. The method of claim 18, further comprising the step of transmitting the record of the identification information to a system comprised from the group consisting of a docking station, a central computer, and a database.

28. The method of claim 18, wherein the identification devices is a device comprised from the group consisting of an active identification device, a passive identification device, and a semi-passive identification device.

29. The method of claim 18, further comprising the step storing, in memory associated with the reader, information about the identification device comprised from the group consisting of date information, time information, and pallet ID information, when identification information corresponding to the electronic identification device is stored.

30. The method of claim 18, further comprising the step of indicating a removed status corresponding to the electronic identification device coupled to each of the one or more items when the electronic identification device is removed from the pallet, thereby tracking the one or more items contained with the pallet at a given time.

31. The method of claim 30, further comprising the step of including status information about the electronic identification device comprised from the group consisting of date information, time information, and pallet ID information as part of the removed status when the identification device coupled to each of the one or more items is removed from the pallet, thereby tracking the one or more items removed from the pallet at a given time.
